(19) United States
(12) Patent Application Publication
(10) Pub. No.: US 2020/0391504 A1
(43) Pub. Date: Dec. 17, 2020

(54) ZONAL ACTUATOR FAULT DETECTION WITH SCAN MODE SIGNAL PROPAGATION

(71) Applicant: Hewlett-Packard Development Company, L.P., Spring, TX (US)

(72) Inventors: Daryl E. Anderson, Corvallis, OR (US); Eric Martin, Corvallis, OR (US)

(73) Assignee: Hewlett-Packard Development Company, L.P., Spring, TX (US)

(21) Appl. No.: 16/955,897

(22) PCT Filed: Mar. 5, 2018
(86) PCT No.: PCT/US2018/020864

§ 371 Date: Jun. 19, 2020

(51) Int. Cl. B41J 2/045

(52) U.S. Cl. CPC B41J 2/0451; B41J 2/0452; B41J 2/04581

(57) ABSTRACT

In one example in accordance with the present disclosure, a fluidic die is described. The fluidic die includes an array of fluid actuators grouped into zones. Each zone includes a number of fluid actuators and a first fault detection device. The first fault detection device includes a first comparator to compare at least one of a supply voltage and a return voltage supplied to the zone against a voltage threshold and a first fault capture device. The first fault capture device, during an evaluation mode, stores a signal indicating an output of the first comparator. The first fault capture device, during a scan mode, propagates the signal through subsequent fault capture devices to a controller.

### BACKGROUND

A fluidic die is a component of a fluidic system. The fluidic die includes components that manipulate fluid flowing through the system. For example, a fluidic ejection die, which is an example of a fluidic die, includes a number of nozzles that eject fluid onto a surface. The fluidic die also includes non-ejecting actuators such as micro-recirculation pumps that move fluid through the fluidic die. Through these nozzles and pumps, fluid, such as ink and fusing agent among others, is ejected or moved.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluidic die for zonal actuator evaluation with scan mode signal propagation, according to an example of the principles described herein.

FIG. 2 is a diagram of a fluidic die for zonal actuator evaluation with scan mode signal propagation, according to an example of the principles described herein.

FIG. 3 is a flow chart of a method for zonal actuator evaluation with scan mode signal propagation, according to an example of the principles described herein.

FIGS. 4A and 4B are circuit diagrams of a fluidic die for zonal actuator evaluation with scan mode signal propagation, according to an example of the principles described herein.

FIG. 5 is an example of a die fault signal, according to an example of the principles described herein.

FIG. 6 is a flow chart of a method for zonal actuator evaluation with scan mode signal propagation, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Fluidic dies, as used herein, may describe a variety of types of integrated devices with which small volumes of fluid may be pumped, mixed, analyzed, ejected, etc. Such fluidic dies may include ejection dies, such as those found in printers, additive manufacturing distributor components, digital titration components, and/or other such devices with which volumes of fluid may be selectively and controllably ejected.

In a specific example, these fluidic systems are found in any number of printing devices such as inkjet printers, multi-function printers (MFPs), and additive manufacturing apparatuses. The fluidic systems in these devices are used for precisely, and rapidly, dispensing small quantities of fluid. For example, in an additive manufacturing apparatus, the fluid ejection system dispenses fusing agent. The fusing agent is deposited on a build material, which fusing agent facilitates the hardening of build material to form a three-dimensional product.

Other fluid systems dispense ink on a two-dimensional print medium such as paper. For example, during inkjet printing, fluid is directed to a fluid ejection die. Depending on the content to be printed, the device in which the fluid ejection system is disposed determines the time and position at which the ink drops are to be released/ejected onto the print medium. In this way, the fluid ejection die releases multiple ink drops over a predefined area to produce a representation of the image content to be printed. Besides paper, other forms of print media may also be used.

Accordingly, as has been described, the systems and methods described herein may be implemented in a two-dimensional printing, i.e., depositing fluid on a substrate, and in three-dimensional printing, i.e., depositing a fusing agent or other functional agent on a material base to form a three-dimensional printed product.

Each fluidic die includes a fluid actuator to eject/move fluid. In a fluidic ejection die, a fluid actuator may be disposed in an ejection chamber, which chamber has an opening. The fluid actuator in this case may be referred to as an ejector that, upon actuation, causes ejection of a fluid drop via the opening.

Fluid actuators may also be pumps. For example, some fluidic dies include microfluidic channels. A microfluidic channel is a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Fluidic actuators may be disposed within these channels which, upon activation, may generate fluid displacement in the microfluidic channel.

Examples of fluid actuators include a piezoelectric membrane based actuator, a thermal resistor based actuator, an electrostatic membrane actuator, a mechanical/impact driven membrane actuator, a magneto-strictive drive actuator, or other such elements that may cause displacement of fluid responsive to electrical actuation. A fluidic die may include a plurality of fluid actuators, which may be referred to as an array of fluid actuators.

While such fluidic systems and dies undoubtedly have advanced the field of precise fluid delivery, some conditions impact their effectiveness. For example, the power delivery regime of a fluidic die may not be able to keep up with other technological changes to the fluidic die. For example, as fluidic dies shrink in size to meet consumer demand or as more circuit elements are added between the power source and the array of fluid actuators, power delivery becomes more difficult as there are fewer thin film layers through which power can be delivered and more components that act as a source of parasitic loss. Each of these circumstances may have a deleterious effect on fluidic performance.

For example, the energy a fluid actuator uses to effectuate fluid manipulation is related to the voltage difference across it. Accordingly, a drop in electrical power may affect the fluid actuator's ability to perform an operation such as fluidic ejection or fluidic movement. As a specific numeric example, an actuator array may be optimized to operate when coupled to a 32 V supply signal and a ground signal. However, due to parasitic losses, which may be more prevalent with reduced size components, the supply voltage that is actually seen by an actuator in the array may be 28 V and the power return node at the same actuator may be at 3V instead of 0 V due to parasitic rise. Consequently, instead of 2 C across the actuator, there would be 25 V across the actuator. This reduced voltage across the actuator array may result in an actuation of the actuator that is not full strength and thus affects ejection/movement of the fluid, or may not result in any ejection/movement at all. Such losses may be more prevalent at those positions along the array furthest from a power supply or a return, for example, a middle region of a column array.

Accordingly, the present specification is directed to a fluidic die that includes multiple arrays of fluid actuators, each of the arrays being divided into zones of fluid actuators. Components within each zone monitor power delivered to fluid actuators in that zone. Specifically, during an evaluation mode, a component within the zone determines if a supply voltage level drops below a threshold value or if a return voltage level rises above a threshold value. If so, fault-indicating data is then stored within the zone. Then, during a scan mode, the data is propagated down through the array such that a die fault signal is generated. From the die fault signal, a location and type of fault can be identified to the printer. The printer could then make any variety of adjustments including adjusting print masks, power settings, or other parameters to bring the power delivery to each zone back to a desired level. Specifically, a controller could increase the supply voltage, reduce the number of nozzles that are fired at the same time, and slow down the print speed so that the amount of fluid per area remains the same as before. As such, a device in which the fluidic die is included, can optimize printing based on actual power delivery to the fluidic die and that is specific to that fluidic die.

Specifically, the present specification describes a fluidic die. The fluidic die includes an array of fluid actuators grouped into zones. Each zone includes a number of fluid actuators and a first fault detection device. The first fault detection device includes 1) a first comparator to compare at least one of a supply voltage and a return voltage supplied to the zone against a voltage threshold and 2) a first fault capture device. The first fault capture device 1) during an evaluation mode, stores a signal indicating an output of the first comparator and 2) during a scan mode, propagates the signal through subsequent fault capture devices to a controller.

In another example, each zone includes a first fault detection device and a second fault detection device. The first fault detection device includes 1) a first comparator to compare a representation of a supply voltage supplied to the zone against a supply voltage threshold and 2) a first fault capture device to store a signal indicating an output of the first comparator. In this example each zone also includes a second fault detection device which includes 1) a second comparator to compare a return voltage from the zone against a return voltage threshold and 2) a second fault capture device to store a signal indicating an output of the second comparator. A detection chain of the fluidic die, during a scan mode, generates a die fault signal by propagating the signals from the fault capture devices through subsequent fault capture devices such that contents of all fault capture devices are conveyed in a serial fashion to a controller.

The present specification also describes a method. According to the method, during an evaluation mode and within each zone, a fault in the zone is determined when at least one of the following conditions exists: a supply voltage to the zone is less than a supply voltage threshold and a return voltage is greater than a return voltage threshold. Still during the evaluation mode, an indication of the fault is stored in a fault capture device. During a scan mode, a sequence of outputs from each zone is propagated through subsequent fault capture devices. The sequence of outputs are indicative of the zone where the fault occurred and a type of the fault.

In one example, using such a fluidic die 1) allows for immediate detection of power faults at a zone level; 2) reports such faults such that remedial action may be taken; 3) allows for identification of a type and location of the fault; 4) allows for a controller to adjust print masks, power distribution, or other parameters, on the fly to optimize for the actual power delivery limitations of the system; and 5) may leverage circuitry used for other zonal sensing systems such as drive bubble detection systems.

As used in the present specification and in the appended claims, the term “actuator” refers to an ejecting actuator and/or a non-ejecting actuator. For example, an ejecting actuator operates to eject fluid from the fluid ejection die. A recirculation pump, which is an example of a non-ejecting actuator, moves fluid through the fluid slots, channels, and pathways within the fluidic die.

Accordingly, as used in the present specification and in the appended claims, the term “nozzle” refers to an individual component of a fluid ejection die that dispenses fluid onto a surface. The nozzle includes at least an ejection chamber, an ejector actuator, and an opening.

Further, as used in the present specification and in the appended claims, the term “fluidic die” refers to a component of a fluid ejection system that includes a number of fluid actuators. A fluidic die includes fluidic ejection dies and non-ejecting fluidic dies.

Still further, as used in the present specification and in the appended claims, the term “array” refers to a grouping of fluid actuators. A fluidic die may include multiple “arrays.” For example, a fluidic die may include multiple columns, each column forming an array.

Even further, as used in the present specification and in the appended claims, the term “zone” refers to a sub-division of an array. For example, a column of fluid actuators may include multiple zones.

Even further, as used in the present specification and in the appended claims, the term “fault capture device,” refers to an electrical component that can store a signal, such as a logic value. Examples of capture devices include flip-flops such as a set-reset flop, a D flip-flop, and others.

Yet further, as used in the present specification and in the appended claims, the term “fault-indicating output” refers to an output of a comparator that indicates a particular fault. For example, a comparator may generate an output indicating that the supply voltage seen at a zone of fluid actuators is less than a threshold amount, which is indicative of a fault. The comparator may then generate an output indicating this fault. In another example, a comparator may generate an output indicating that the return voltage seen at a zone of fluid actuators is greater than a threshold amount, which is indicative of a fault. The comparator may then generate an output indicating this fault.

Even further, as used in the present specification and in the appended claims, the term “fault detection device” refers to hardware components within a zone to determine a fault within that zone. There may be multiple fault detection devices within a zone. For example, a first fault detection device may detect and store a supply fault and a second fault detection device may detect and store a return fault.

Further, as used in the present specification and in the appended claims, the term “supply voltage’ refers to either the supply voltage unaltered, or an altered representation of the supply voltage. For example, the supply voltage may pass first through a voltage reducer to reduce the value of what is supplied to the corresponding comparator.

Finally, as used in the present specification and in the appended claims, the term “a number of” or similar language is meant to be understood broadly as any positive number including 1 to infinity.

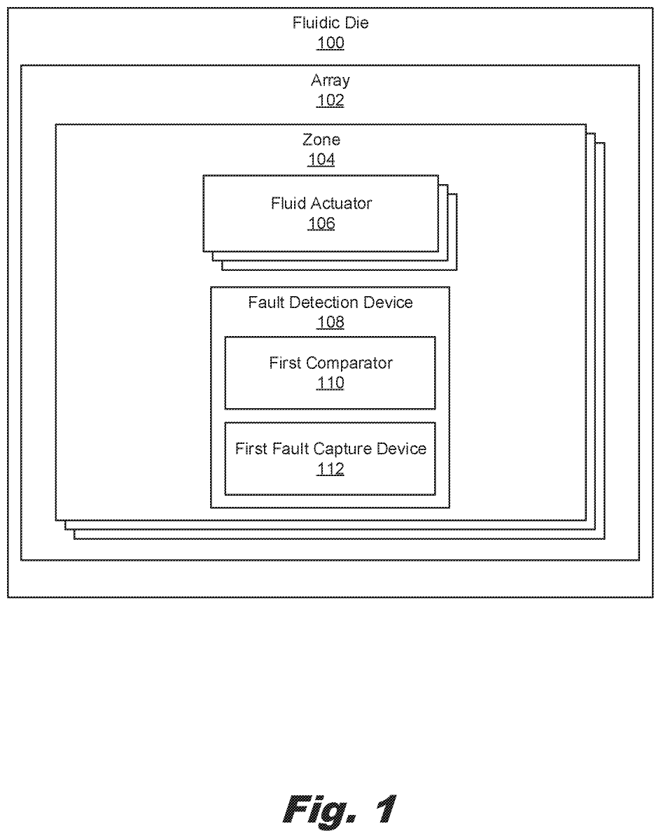

Turning now to the figures, FIG. 1 is a block diagram of a fluidic die (100) for zonal actuator evaluation with scan mode signal propagation, according to an example of the principles described herein. As described above, the fluidic die (100) is a part of a fluidic system that houses components for ejecting fluid and/or transporting fluid along various pathways. In some examples, the fluidic die (100) is a microfluidic die (100). That is, the channels, slots, and reservoirs on the microfluidic die (100) may be on a micrometer, or smaller, scale to facilitate conveyance of small volumes of fluid (e.g., picoliter scale, nanoliter scale, microliter scale, milliliter scale, etc.). The fluid that is ejected and moved throughout the fluidic die (100) can be of various types including ink, biochemical agents, and/or fusing agents. The fluid is moved and/or ejected via an array (102) of fluid actuators (106). Any number of fluid actuators (106) may be formed on the fluidic die (100). The fluidic die (100) may include any number of arrays (102). For example, the different arrays (102) on a fluidic die (100) may be organized as columns. In other examples, the array (102) may take different forms such as an N×N grid of fluid actuators (106).

Each array (102) is divided into different zones (104), a zone (104) referring to a sub-grouping of the fluid actuators (106) within a particular array (102). For example, in one column, i.e., array (102), of fluid actuators (106), multiple zones (104) of eight fluid actuators (106) may be present.

The fluidic die (100) includes a number of fluid chambers to hold a volume of the fluid to be move or ejected. The fluid chamber may take many forms. A specific example of such a fluid chamber is an ejection chamber where fluid is held prior to ejection from the fluidic die (100). In another example, the fluid chamber (100) may be a channel, or conduit through which the fluid travels. In yet another example, the fluid chamber (100) may be a reservoir where a fluid is held.

The fluid chambers (100) formed in the fluidic die (100) include fluid actuators (106) disposed therein, which fluid actuators (106) work to eject fluid from, or move fluid throughout, the fluidic die (100). The fluid chambers and fluid actuators (106) may be of varying types. For example, the fluid chamber may be an ejection chamber wherein fluid is expelled from the fluidic die (100) onto a surface for example such as paper or a 3D build bed. In this example, the fluid actuator (106) may be an ejector that ejects fluid through an opening of the fluid chamber.

In another example, the fluid chamber is a channel through which fluid flows. That is, the fluidic die (100) may include an array of microfluidic channels. Each microfluidic channel includes a fluid actuator (106) that is a fluid pump. In this example, the fluid pump, when activated, displaces fluid within the microfluidic channel. While the present specification may make reference to particular types of fluid actuators (106), the fluidic die (100) may include any number and type of fluid actuators (106).

These fluid actuators (106) may rely on various mechanisms to eject/move fluid. For example, an ejector may be a firing resistor. The firing resistor heats up in response to an applied voltage. As the firing resistor heats up, a portion of the fluid in an ejection chamber vaporizes to generate a bubble. This bubble pushes fluid out an opening of the fluid chamber and onto a print medium. As the vaporized fluid bubble collapses, fluid is drawn into the ejection chamber from a passage that connects the fluid chamber to a fluid feed slot in the fluidic die (100), and the process repeats. In this example, the fluidic die (100) may be a thermal inkjet (TIJ) fluidic die (100).

In another example, the fluid actuator (106) may be a piezoelectric device. As a voltage is applied, the piezoelectric device changes shape which generates a pressure pulse in the fluid chamber that pushes the fluid through the chamber. In this example, the fluidic die (100) may be a piezoelectric inkjet (PIJ) fluidic die (100).

As described above, such fluid actuators (106) rely on energy to actuate. The energy seen by fluid actuators (106) is based on a voltage potential across the fluid actuator (106). Accordingly, each zone (104) is coupled to a supply and a return. If 1) the supply voltage seen by a zone (104) is less than a predetermined threshold, 2) the return voltage from the zone (104) is greater than a predetermined threshold, or 3) combinations thereof, the voltage potential across the zone (104) may be less than the minimum voltage for fluid actuation. Accordingly, the fluid actuators (106) in that zone (104) may underperform, or may not perform at all. Accordingly, each zone (104) includes a fault detection device (108) that detects either kind of fault, i.e., a fault in the supply side or a fault in the return side.

Specifically, a first fault detection device (108) determines a fault on a supply side or a return side and includes a first comparator (110) and a first fault capture device (112). For example, the first comparator (110) may compare a supply voltage supplied to the zone (104) against a supply voltage threshold or may compare a return voltage supplied to the zone (104) against a return voltage threshold. In some examples, additional fault detection devices (108) can be added such that one determines a supply side fault and the other determines a return side fault. As noted above, the supply voltage may be the supply voltage unaltered, or a scaled representation of the supply voltage.

Accordingly, in one example the first comparator (110) receives as input, the supply voltage at this zone (104) or the return voltage and also a respective voltage threshold, which threshold is a cutoff for sending an indication of a fault to a controller of the fluidic die (100). For example, if the array (102) is supplied with a supply voltage of 32 V or a scaled version thereof, the supply voltage threshold may be set at 28 V, or a scaled version thereof. In this example, the first comparator (110) compares the supply voltage seen at the zone (104), which may be less than 32 V, and compares it against the supply voltage threshold of 28 V. If the supply voltage drops below the threshold value, a fault-indicating output is passed to the first fault capture device (112). Similarly, if the supply voltage seen at the zone (104) does not drop below the threshold value, a non-fault-indicating output is passed to the first fault capture device (112). In one example, the representation of the supply voltage may be the supply voltage, unaltered. In another example, the supply voltage may be scaled, or reduced. Note that if the supply voltage is scaled, the supply voltage threshold is scaled to a similar degree.

In another example, the fault detection device (108) determines a fault by analyzing a return side of the voltage differential. In this example, the first comparator (110) compares a return voltage from the zone (104) against a return voltage threshold. That is, the first comparator (110) receives as input, the return voltage leaving this zone (104) and also a return voltage threshold, which threshold is a cutoff for sending an indication of a return fault to a controller of the fluidic die (100). For example, if the array (102) is grounded to 0 V, the return voltage threshold may be set at 3 V. In this example, the first comparator (110) compares the return voltage seen at the zone (104), which may be greater than 0 V due to parasitic losses on the return supply line, and compares it against the return voltage threshold of 3 V. If the return voltage rises above the threshold value, a fault indicating output is passed to the first fault capture device (112). Similarly, if the return voltage seen at the zone (104) does not rise above the threshold value, a non-fault indicating output is passed to the first fault capture device (112).

In other words, the first fault detection device (108) outputs a signal, which signal indicates either 1) a fault based on a fault-indicating output of the first comparator (110) or 2) that the corresponding zone (104) is in a non-fault state. In this case, a fault-indicating output indicates either 1) that the supply voltage at the zone (104) is less than the supply voltage threshold or 2) that the return voltage at the zone (104) is greater than the return voltage threshold.

Note that in this example, the first fault detection device (108) can determine a fault either based on a supply voltage or a return voltage within the zone (104). Making such a determination based on just one side of the voltage differential is beneficial in that it reduces the circuitry on a fluidic die (100). Moreover, as the voltage differential between supply and threshold and return and threshold are mirrors, an overall drop in voltage differential based on the supply voltage and return voltage can be determined.

The first fault capture device (112) is a component of the first fault detection device (108) that receives the output of the first comparator (110). The first fault capture device (112) in some examples may pass its contents onto a subsequent fault capture device (112) such that an output of a detection chain that passes through the different fault detection devices (108) on the array (102), includes contents of all fault capture devices (112) on the fluidic die (100) which are conveyed in a serial fashion to a controller.

The fault detection device (108) operates in two modes. During an evaluation mode, an output of the comparator (110) within the zone (104) is stored and then during a scan mode, the stored signal is propagated through to subsequent fault capture devices (112) to a controller. For example, during the evaluation mode, the first fault capture device (112) responds to a fault detected by the first comparator (110) and stores that value. During the scan mode, the first fault capture device (112) no longer responds to the first comparator (110). For example, the first comparator (110) may be disabled. Still during the scan mode, the contents of the first fault capture device (112) which were initially stored, are propagated based on a clock cycle towards the controller. In this fashion, an input of the controller is a sequence of bits that 1) indicate a location, i.e. a zone (104), where a fault occurred, and 2) a type of fault, i.e., whether it occurred on the supply side or return side of the zone (104).

Such a fluidic die (100) accounts for drops of power by providing an indication when power levels along the fluidic die (100) are insufficient to effectuate proper fluid actuation. For example, when, due to any number of circumstances, a particular zone (104) does not have sufficient voltage potential between its supply and return terminals to actuate fluid as configured, the fault detection device (108) is triggered and an output passed to a controller of the fluidic die (100) such that a remedial action, such as adjusting the print mask, the power distribution, the print speed, or firing parameters can be carried out. Moreover, during the evaluation mode and scan mode, in addition to simply indicating that a fault has occurred, a type of fault, and location of the fault can be determined.

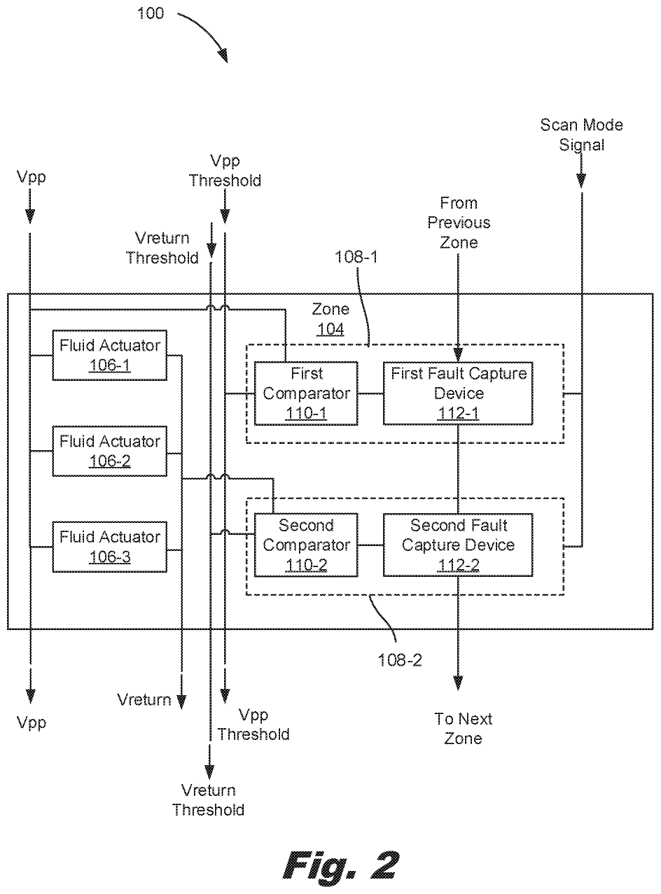

FIG. 2 is a diagram of a fluidic die (FIG. 1, 100) for zonal actuator evaluation with scan mode signal propagation, according to an example of the principles described herein. Specifically, FIG. 2 depicts a zone (104) of an array (FIG. 1, 102). As noted above, a fluidic die (FIG. 1, 100) may include any number of arrays (FIG. 1,102), which arrays (FIG. 1, 102) may be configured in any number of ways, including in columns.

Moreover, as described above, each zone (104) includes a number of fluid actuators (106). For simplicity, in FIG. 2, three fluid actuators (106) are depicted in a zone (104), but a zone (104) may include any number of fluid actuators (106). An energy potential is applied across the fluid actuators (106) in a zone (104) by coupling each zone (104) of fluid actuators (106) to a supply voltage, Vpp, and a return voltage, Vreturn. Each of the supply voltage, Vpp, and the return voltage, Vreturn, are coupled to each zone (104) in the array (FIG. 1, 102). That is, Vpp and Vreturn are global to zones (104) of the array (FIG. 1, 102). However, the voltages of Vpp and Vreturn at each zone (104) may be different due to different levels of parasitic loss along the path. The voltage differential between these two values Vpp and Vreturn at a particular zone (104) indicate whether or not the fluid actuators (106) in that zone (104) are receiving sufficient power to operate as expected. Accordingly, fault detection devices (108) are implemented to measure such a voltage difference and determine whether or not a fault, i.e., an insufficient voltage difference, exists in that zone (104).

As described above, in some examples, the fluidic die (FIG. 1, 100) includes a first comparator (110-1) and a first fault capture device (112-1) to analyze at least one of a supply voltage and a return voltage against a respective threshold. In some examples, the fluidic die (FIG. 1, 100) includes additional comparators (110) and capture devices (112) as depicted in FIG. 2.

Accordingly, in a first fault detection device (108-1), the supply voltage, Vpp, and a supply voltage threshold, Vpp threshold, are passed to a first comparator (110-1). Note that the same voltage supply threshold, Vpp threshold, is passed to each zone (104) in an array (FIG. 1, 102) of fluid actuators (106). The first comparator (110-1) compares these two voltages and generates an output that is passed to the first fault capture device (112-1).

In this example, in a second fault detection device (108-2), the return voltage, Vreturn, and a return voltage threshold, Vreturn threshold, are passed to a second comparator (110-2). Note that the same return voltage threshold, Vreturn threshold, is passed to each zone (104) in an array (FIG. 1, 102) of fluid actuators (106). The second comparator (110-2) compares these two voltages and generates an output that is passed to the second fault capture device (112-2).

The fault detection devices (108) may operate differently in different modes. For example, during an evaluation mode outputs of the comparators (110) are stored in the respective fault capture devices (112) and held there. Then during a scan mode, the output signals are propagated along a detection chain which includes the various fault capture devices (112) through each zone (104) to generate a die fault signal at the controller. In this fashion, contents of all fault capture devices (112) are conveyed in a serial fashion to a controller.

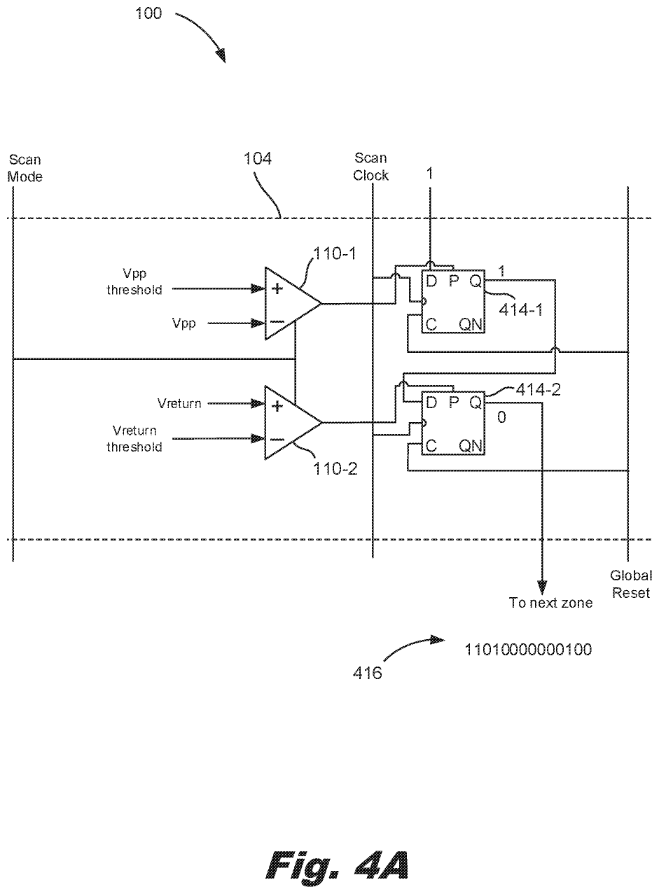

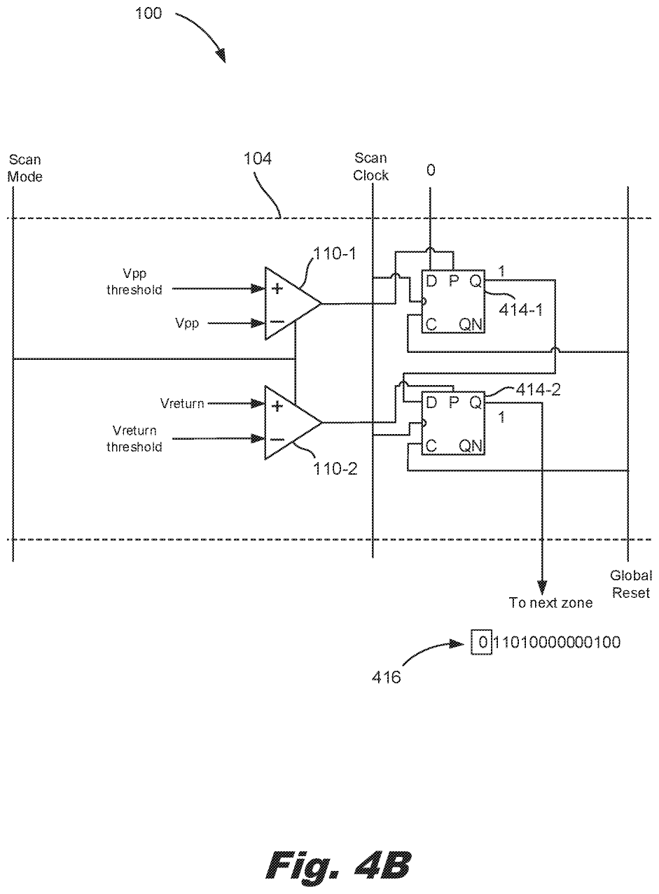

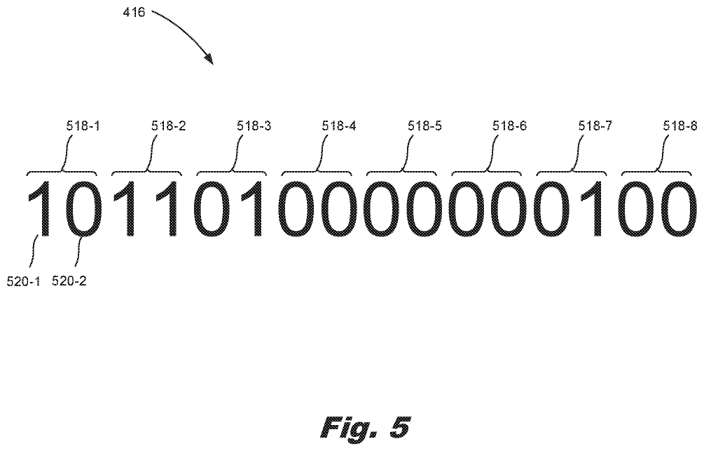

More details regarding the propagation of contents of the fault capture devices (112) and the die fault signal are provided below in connection with FIGS. 4A, 4B, and 5.

The timing of the different modes is determined based on system activity. For example, in a printer or fluid manipulation device, it may be desirable to minimize bandwidth and actuation response time during actuation events. Accordingly, during this actuation period, the fluidic die (FIG. 1, 100) may be in an evaluation mode and simply make and store measurements indicative of actuator faults, but not indicate specific zones (104) or types of faults. Then, during an idle time such as during a diagnostic period or between printing swaths, the fault detection device (108) circuits enter a scan mode wherein more time may be available for propagating the fault-indicating signals through the fluidic die (FIG. 1, 100) to the controller where they may be analyzed and processed.

The activation of the scan mode is initiated via a scan mode signal from a controller. Such a scan mode signal triggers any number of configurations. Specifically, during the scan mode, the fault capture devices (112) do not respond to faults during the scan mode. Accordingly, the scan mode signal may disable the comparators (110) of each fault detection device (108).

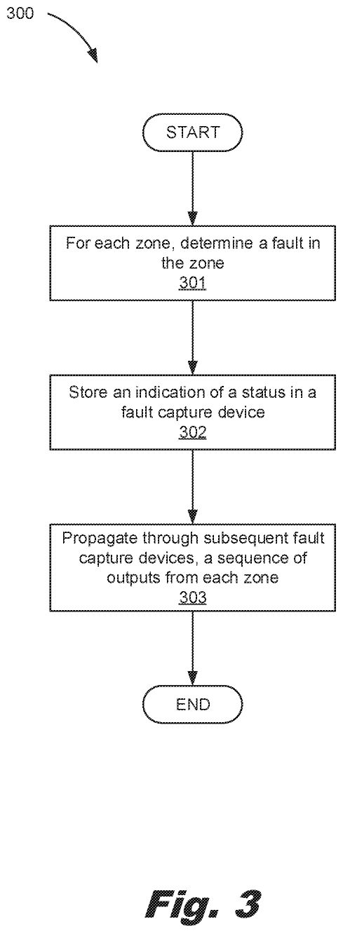

FIG. 3 is a flow chart of a method (300) for zonal actuator evaluation with scan mode signal propagation, according to an example of the principles described herein. According to the method, a fault is determined (block 301) in each zone (FIG. 1, 104). That is, it may be determined whether a zone (FIG. 1, 104) has a fault or is operating as expected. A fault occurs when either a supply voltage to the zone (FIG. 1, 104) is less than a supply voltage threshold or a return voltage to the zone (FIG. 1, 104) is greater than a return voltage threshold. In some cases just one of the supply voltage or return voltage is tested, for example via one comparator (FIG. 1, 110) and one fault capture device (FIG. 1, 112). In another example, both are tested, for example via a first comparator (FIG. 2, 110-1) to test a supply voltage and a second comparator (FIG. 2, 110-2) to test a return voltage. When either of these conditions exists, a fault is indicated and an indication of the status is stored (block 302) in a fault capture device (FIG. 1, 112).

When just one of a supply voltage or return voltage is tested, the storage (block 302) may be at a single fault capture device (FIG. 1, 112). By comparison, when both of the supply voltage and return voltage are tested, the storage (block 302) of the indication may include storing (block 302) an indication of a status of a supply side at a first fault capture device (FIG. 2, 112-1) and storing (block 302) an indication of a status of a return side at a second fault capture device (FIG. 2, 112-2). Note that the determination (block 301) and storage (block 302) occur during an evaluation mode, for example as a printer is actively printing, that is as the actuators are actively actuating fluid.

A specific example is now provided the evaluation mode during which the determination (block 301) of a status in the zone (FIG. 1, 104) by analyzing both the supply voltage and the return voltage, and storage (block 302) of an indication of either type of fault in a corresponding fault capture device (FIG. 1, 112). During this evaluation period, a supply voltage, Vpp, supplied to a particular zone (FIG. 1, 104) is compared against a supply voltage threshold, Vpp threshold. As described above, this may occur at the first comparator (FIG. 2, 110-1) of the zone (FIG. 1, 104). The supply voltage threshold, Vpp threshold, may be any value less than the supply voltage, Vpp, where it is deemed that sub-threshold voltages would result in less than a desired level of performance by the fluid actuators (FIG. 1, 106) in that zone (FIG. 1, 104). Note also that the supply voltages, Vpp, may differ at different zones (FIG. 1, 104). Accordingly, by comparing the supply voltage threshold, Vpp threshold, with the specific supply voltage, Vpp, seen at a zone (FIG. 1, 104), a localized result based on the actual operation of a particular fluid system can be determined.

As noted the representation of the supply voltage, Vpp, may include the actual supply voltage itself or a scaled version. The scaled version may be desirable for example, when the first comparator (FIG. 2, 110-1) is a low-voltage comparator, for consistency with the second comparator (FIG. 2, 110-2) which may be a low-voltage comparator. In this example, a high voltage source may damage the low-voltage first comparator (FIG. 2, 110-1).

Still during this evaluation period, the return voltage, Vreturn, from a particular zone (FIG. 1, 104) is compared against a return voltage threshold, Vreturn threshold. As described above, this may occur at the second comparator (FIG. 2, 110-2) of the zone (FIG. 1, 104). The return voltage threshold, Vreturn threshold, may be any value greater than the return voltage, Vreturn, where it is deemed that supra-threshold voltages would result in a less than desired level of performance by the fluid actuators (FIG. 1, 106) in that zone (FIG. 1, 104). Note also that the return voltages may vary between zones (FIG. 1, 104). Accordingly, by comparing the return voltage threshold, Vreturn threshold, with the specific return voltage, Vreturn, seen at a zone (FIG. 1, 104), a localized result based on the actual operation of a particular fluid system can be determined.

The system can determine a fault in the zone (FIG. 1, 104). Specifically, a fault is determined when either 1) the supply voltage, Vpp, at the zone (FIG. 1, 104) is less than the supply voltage threshold, Vpp threshold or 2) the return voltage, Vreturn, at the zone (FIG. 1, 104) is greater than the return voltage threshold, Vreturn threshold. For example, given a supply voltage threshold of 28 V and a return voltage threshold of 3 V, a fault may be determined when the supply voltage, Vpp, at the zone (FIG. 1, 104) falls below 28 V or the return voltage, Vreturn, at the zone (FIG. 1, 104) is greater than 3 V. When either of these cases exists, it is indicative that a voltage potential across the zone (FIG. 1, 104) is insufficient to allow fluid actuator (FIG. 1, 106) operation as intended.

Data indicating a fault or no fault is stored (block 302) at respective capture devices (FIG. 1, 112). In some examples, the data may be in the form of a logic bit that is stored on a memory unit such as a flop.

Following this evaluation mode, the fault detection devices (FIG. 1, 108) are placed in a scan mode wherein that information stored in each fault capture device (FIG. 1, 112) is propagated through other fault capture devices (FIG. 1, 112). That is, whatever is stored on a first fault capture device (FIG. 2, 112-1) whether it indicates a fault, i.e., logic “1,” or no fault, i.e., logic “0”, is passed to the second fault capture device (FIG. 2, 112-2). At the same time, the contents of the second fault capture device (FIG. 2, 112-2) are passed to a subsequent fault capture device (FIG. 1, 112). The last fault capture device (FIG. 1, 112) propagates its contents to a controller where it is appended to an existing string of contents. Accordingly, the output of the detection chain of the fluidic die (FIG. 1, 100) is a sequence of bits that are reflective of a reverse order of the fault capture devices (FIG. 1, 112). Accordingly, from this output it can be determined a location where a fault occurred and whether that fault is a supply-side fault, or a return-side fault, i.e., what type of fault occurred.

FIGS. 4A and 4B are circuit diagrams of a fluidic die (100) for zonal actuator evaluation with scan mode signal propagation, according to an example of the principles described herein. Specifically, FIGS. 4A and 4B depict the fault detection devices (FIG. 1, 108) at different clock cycles within a scan mode. FIG. 4A depicting a first clock cycle and FIG. 4B depicting a second clock cycle.

As described above, each zone (104) includes a first comparator (110-1). In this example, the first comparator (110-1) monitors the supply voltage, Vpp, and a second comparator (110-2) monitors the return voltage, Vreturn, which return voltage is the supply that returns current from the fluidic actuators (FIG. 1, 106) back to the power supply device. In some examples, the return voltage is referred to as ground. Also as described above, each fault detection device (FIG. 1, 108) includes a fault capture device (FIG. 1, 112). In the example depicted in FIGS. 4A and 4B, the fault capture devices (FIG. 1, 112) are D-flops with preset and clear inputs (414-1, 414-2). Note that while one particular type of selectable memory element is indicated others may also be used.

During the evaluation mode, each comparator (110) is coupled to a respective fault capture device (FIG. 1, 112). Accordingly, when a fault is detected via comparing the respective supply voltage, Vpp, or return voltage, Vreturn, against its corresponding threshold, that value is passed to the preset P input of the D-flops with preset and clear inputs (414-1, 414-2).

Then after switching from an evaluation mode to a scan mode, a number of things occur. Such a switch may be triggered by a scan mode signal that alters the operation of the fault detection device (FIG. 1, 108). Specifically, the fault capture devices (FIG. 1, 112) are switched such that they do not respond to faults. As one particular example, the scan mode signal may disable the comparators (110) such that they no longer generate an output based on their comparison. Other examples are also available of disabling the fault detection aspect of the fault detection device.

Another thing that occurs during the scan mode is that each fault capture device (FIG. 1, 112) sends its contents to an adjacent fault capture device. That is, the scan clock triggers the passing of whatever is stored on that fault capture device (FIG. 1, 112) to a subsequent fault capture device (FIG. 1, 112). Put another way, during a clock cycle of the scan mode, each fault capture device (FIG. 1, 112) 1) passes contents stored therein to a downstream fault capture device (FIG. 1, 112) and 2) receives contents stored at an upstream fault capture device (FIG. 1, 112). Through a number of these clock cycles an output of the array (FIG. 1, 102) of zones (104) is a sequence of bits that correspond to an ordering of the actuators (FIG. 1, 106), which sequence can be used to determine a zone where a fault occurred and a type of fault that occurred in that zone (FIG. 1, 104). A specific example of shifting of fault-indicating data will now be provided.

Prior to any fault detection, an output of the first comparator (110-1) may indicate expected operation, i.e., that the supply voltage, Vpp, at the zone (104) is greater than or equal to the supply voltage threshold, Vpp threshold. In this example, an output indicating expected operation is represented by logic “0.” This value is passed to the preset port of the D-flops with preset and clear inputs (416-1, 416-2) and set on the output terminal “Q.” In the event that the supply voltage, Vpp, falls below the threshold, Vpp threshold, the output of the first comparator (110-1) will transition from a “0” to a “1” which is passed to the “Q” terminal of the D-flops with preset and clear inputs (416).

In this example, the first comparator (110-1) has its “+” terminal connected to the Vpp threshold voltage, Vpp threshold, which is provided globally to all zones (104). The “−” terminal of the first comparator (110-1) is connected to the representation of the supply voltage, Vpp.

In this example, the second comparator (110-2) has its “−” terminal connected to the return threshold voltage, Vreturn threshold, which is provided globally to all zones (104). The “+” terminal of the second comparator (110-2) is connected to the return voltage, Vreturn.

Similarly, prior to any fault detection, an output of the second comparator (110-2) may indicate expected operation, i.e., that the return voltage, Vreturn, at the zone (104) is less than or equal to the return voltage threshold, Vreturn threshold. In this example, an output indicating expected operation is represented by logic “0.” This value is passed to the preset input, P, of the D-flops with preset and clear inputs (416-2) and set on the output terminal “Q.” In the event that the return voltage, Vreturn, rises above the threshold, Vreturn threshold, the output of the second comparator (110-2) will transition from a “0” to a “1” which is passed to the “Q” terminal of the D-flops with preset and clear input (416-2). In the example depicted in FIG. 4A, an upstream fault capture device (FIG. 1, 112) has a logic value of “1” stored thereon, the first D-flops with preset and clear inputs (414-1) has a logic value of “1” stored thereon, and the second D-flops with preset and clear input (414-2) has a logic value of “0” stored thereon and die fault signal has the sequence “11010000000100.”

When the switch is made to a scan mode, the comparators (110) are disabled and a scan clock triggers the shifting of contents of fault capture devices (FIG. 1, 112) to subsequent fault capture devices (FIG. 1, 112). For example, as depicted in FIG. 4B, the contents of the second D-flop with preset and clear inputs (414-2), “0”, are appended to the die fault signal (416) and the contents of the first D-flop with preset and clear inputs (414-1), “1” is passed to the second D-flop with preset and clear inputs (414-2). Similarly, previous contents of the previous fault capture device, “1”, are shifted to the first D-flop with preset and clear inputs (414-2). In subsequent cycles, triggered by the scan dock signal, the contents of that first D-flop with preset and clear inputs (414-1) and previous fault capture devices in FIG. 4B, i.e., “1” and “0” respectively will be passed through the second D-flop with preset and clear inputs (414-2) and other subsequent flops to be eventually appended to the die fault signal (416). As a result a die fault signal includes bits that map to the different zones (104) and comparators (110) within that zone to allow identification of 1) a zone (104) where a fault occurred and a type of fault, i.e., which comparator (110), a supply-side comparator or a return-side comparator, triggered the fault bit.

Each fault detection device (FIG. 1, 108) includes a reset device, in this example the “C” terminal and the global reset line, to reset the respective fault capture device (FIG. 1, 112), in this example, the D-flops with preset and clear inputs (414-1, 414-2) after the fault has been acknowledged by a controller.

While FIGS. 4A and 4B depict an example with multiple comparators (110) and fault capture devices (112) similar operations would exist with a single comparator (110) and fault capture device (112) where an output is stored during evaluation, and then passed during a scan mode to generate a die fault signal (416) that maps to the different fault detection devices (108) thus allowing identification of fault zones and types of fault.

FIG. 5 is an example of a die fault signal (416), according to an example of the principles described herein. As described above, during the scan mode signals, such as logic values, are passed through each fault capture device (FIG. 1, 112) and appended to one another to form the die fault signal (416). Accordingly, the die fault signal (416) includes the sequential output of each zone (FIG. 1, 104). Specifically, the die fault signal (416) may be a sequence of bits. Pairs (518) of bits correspond to a single zone (FIG. 1, 104). For example, a first pair (518-1) may correspond to a first zone (FIG. 1, 104-1) in an array and a second pair (518-2) may correspond to a second zone (FIG. 1, 104-2). Within each pair (518), different bits indicate different fault types. For example, a first bit (520-1) may indicate whether or not a fault occurs on a supply-side of the zone (FIG. 1, 104). In the example depicted in FIG. 5, the presence of the “1” indicates that within the corresponding zone (FIG. 1, 104) a fault was detected by the supply-side comparator. A second bit (520-2) may indicate whether or not a fault occurs on a return-side of the zone (FIG. 1, 104). In the example depicted in FIG. 5, the presence of the “0” indicates that within the corresponding zone (FIG. 1, 104) a fault was not detected by the return-side comparator.

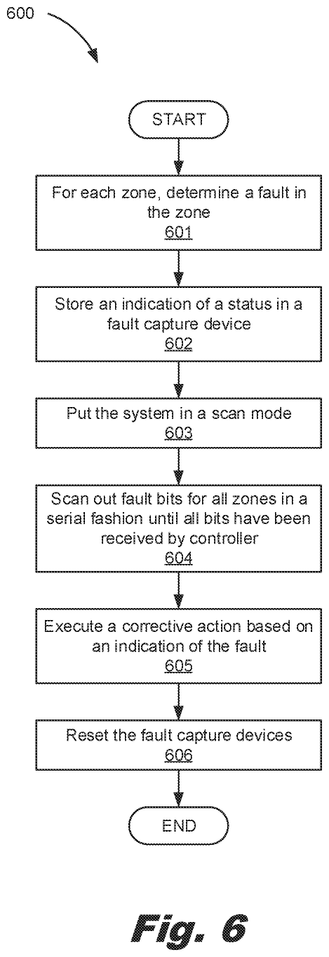

FIG. 6 is a flow chart of a method (600) for zonal actuator evaluation with scan mode signal propagation, according to an example of the principles described herein. As described above, each zone (FIG. 1, 104) operates within an evaluation mode or a scan mode. During the evaluation mode, fault detection devices (FIG. 1, 108) in each zone determine (block 601) whether a fault exists within that zone (FIG. 1, 104) and stores (block 602) an indication of a status (i.e., fault, or lack thereof) in the fault capture devices (FIG. 1, 112) of that zone (FIG. 1, 104). This may be done as described above in connection with FIG. 3.

The fault detection devices (FIG. 1, 108) are then put (block 603) in a scan mode wherein the stored contents indicating faults or lack thereof, are passed to a controller via a shifting operation. For example, in the scan mode, fault bits for each zone (FIG. 1, 104) are scanned out (block 604) in a serial fashion until all bits have been received by a controller. That is, each fault capture device (FIG. 1, 112) receives a fault detection bit from an upstream fault capture device (FIG. 1, 112). The fault detection bit has one value that indicates a fault and one value that indicates no fault. Whatever the value of the bit, that fault detection bit is received (block 603) from the upstream fault capture device. The contents of each fault capture device (FIG. 1, 112) are also shifted to a downstream fault capture device (FIG. 1, 112) which may or may not be in the same zone (FIG. 1, 104). Accordingly, an output of the detection chain, i.e., the die fault signal (FIG. 4, 416) is a sequence of fault detection bits from the various zones (FIG. 1, 104). With a fault location and a fault type identified, corrective actions may then be executed (block 605) based on an indication of the fault. For example, print masks may be adjusted, power settings may be adjusted, and other parameters may be adjusted. In one example, the corrective action includes providing a notification to a printer or a user such that manual corrective actions such as maintenance or replacement may occur. Following such corrective action, the fault capture devices (FIG. 1, 112) may be reset (block 606) to no longer indicate a fault.

In one example, using such a fluidic die 1) allows for immediate detection of power faults at a zone level; 2) reports such faults such that remedial action may be taken; 3) allows for identification of a type and location of the fault; 4) allows for a controller to adjust print masks, power distribution, or other parameters, on the fly to optimize for the actual power delivery limitations of the system; and 5) may leverage circuitry used for other zonal sensing systems such as drive bubble detection systems.

What is claimed is:

1. A fluidic die, comprising:
an array of fluid actuators grouped into zones, each zone comprising:
a number of fluid actuators;
a first fault detection device comprising:
a first comparator to compare at least one of a supply voltage and a return voltage supplied to the zone against a voltage threshold; and
a first fault capture device,
wherein the first fault capture device:
during an evaluation mode, stores a signal indicating an output of the first comparator; and
during a scan mode, propagates the signal through subsequent fault capture devices to a controller.

2. The fluidic die of claim 1, further comprising a reset device to reset the first fault capture device when a corrective action has been taken to address a fault.

3. The fluidic die of claim 1, wherein the scan mode is activated via a scan mode signal from a controller.

4. The fluidic die of claim 3, wherein the scan mode signal disables the first comparator.

5. The fluidic die of claim 1, wherein the first fault capture device does not respond to faults during the scan mode.

6. The fluidic die of claim 1, wherein:
during a clock cycle of the scan mode, the first fault capture device:
passes contents stored therein to a downstream fault capture device;
receives contents stored at an upstream fault capture device; and
an output to the controller is a sequence of fault detection bits from the various zones.

7. The fluidic die of claim 1, wherein:
each zone further comprises:
a second fault detection device comprising:
a second comparator to compare a return voltage from the zone against a return voltage threshold; and
a second fault capture device,
wherein the second fault capture device:
during an evaluation mode, stores an output of the second comparator; and
during a scan mode, propagates the signal through subsequent fault capture devices to the controller.

8. The fluidic die of claim 7, wherein each fault capture device:
during the evaluation mode, is coupled to a respective comparator; and
during the scan mode, passes signals to an adjacent fault capture device.

9. A fluidic die, comprising:
an array of fluid actuators grouped into zones, each zone comprising:
a number of fluid actuators;
a first fault detection device comprising:
a first comparator to compare a supply voltage supplied to the zone against a supply voltage threshold; and
a first fault capture device to store a signal indicating an output of the first comparator; and
a second fault detection device comprising:
a second comparator to compare a return voltage from the zone against a return voltage threshold; and
a second fault capture device to store a signal indicating an output of the second comparator; and
a detection chain to, during a scan mode, generate a die fault signal by propagating the signals from the fault capture devices through subsequent fault capture devices such that contents of all fault capture devices are conveyed in a serial fashion to a controller.

10. The fluidic die of claim 9, wherein:
a die fault signal is a sequence of bits, wherein:
pairs of bits correspond to a single zone;
a first bit of the pair indicating a supply fault; and
a second bit of the pair indicating a return fault.

11. The fluidic die of claim 9, wherein at least one of the first fault capture device and the second fault capture device comprise a selectable memory unit.

12. The fluidic die of claim 9, wherein:
a fault-indicating output of the first comparator indicates the supply voltage is less than the supply voltage threshold; and
a fault-indicating output of the second comparator indicates the return voltage is greater than the return voltage threshold.

13. A method comprising:
during an evaluation mode:
for each zone of fluid actuators:
determining a fault in the zone when at least one of the following conditions exists:
a supply voltage to the zone is less than a supply voltage threshold; and
a return voltage is greater than a return voltage threshold; and
storing an indication of a status in a fault capture device; and
during a scan mode propagating, through subsequent fault capture devices, a sequence of outputs from each zone, the sequence indicative of the zone where the fault occurred and a type of the fault.

14. The method of claim 13, further comprising executing a corrective action based on an indication of the fault.

15. The method of claim 13, wherein propagating a sequence of outputs through subsequent fault capture devices comprises:
during a clock cycle of the scan mode:
receive a signal from an upstream fault capture device; and
shift the signal from the upstream fault capture device to a downstream fault capture device such that an output of the detection chain is a sequence of signals from the various zones.
